(19) United States
(12) Patent Application Publication
(10) Pub. No.: US 2016/0319765 A1
(43) Pub. Date: Nov. 3, 2016

(54) Electrically Detecting Position of Fuel Admission Valves

(71) Applicant: Caterpillar Inc., Peoria, IL (US)

(72) Inventor: Andrew J. Neaville, Mt. Pulaski, IL (US)

(73) Assignee: Caterpillar Inc., Peoria, IL (US)

(21) Appl. No.: 14/699,586

(22) Filed: Apr. 29, 2015

(51) Int. Cl. F02D 41/38; F02D 41/26; F02D 41/00; F02D 41/24

(52) U.S. Cl. CPC F02D 41/3809; F02D 41/2406; F02D 41/26; F02D 41/0025

(57) ABSTRACT

An internal combustion engine including a fuel system and cylinders is described. A gaseous fuel admission valve is associated with each cylinder and configured to connect the fuel system with each respective cylinder. A control unit is electrically connected to each of gaseous fuel admission valves and, for each gaseous fuel admission valve, configured to provide an opening electrical current to open the gaseous fuel admission valve, a holding electrical current to hold the gaseous fuel admission valve in an open position and a detection electrical current to detect the position of the gaseous fuel admission valve. The control unit is further configured to determine whether the gaseous fuel admission valve is closed based on the time required to achieve the detection electrical current.

### TECHNICAL FIELD

This disclosure relates generally to engine systems and, more particularly, to fuel admission valve systems and methods.

### BACKGROUND

Internal combustion engines may include fuel admission valves such as gaseous fuel admission valves (“GAVs”) positioned between a fuel source, such as a fuel tank containing natural gas, and an air intake of the engine. When a valve is open, the gaseous fuel passes into an air intake for mixing with the engine intake air. The valve is generally located in close proximity to the combustion chamber.

Due to their positioning close to the combustion chamber, valves may be susceptible to contamination and increased wear. Small particles may become trapped in the valve, for example, between the movable plate and the stationary plate or the seat of the solenoid actuated GAV, and the valve may no longer close properly. Wear as well as contamination of the valve may result in the valve not fully closing.

In some instances, a current can be applied to a valve to determine whether it is operating properly. For example U.S. Pat. No. 7,314,370 (“the '370 patent”) describes a system for verifying proper operation of a valve. A valve is opened and then closed normally. Then the valve is opened again and the system checks to ensure that the valve opened properly. As is known, methods, such as the one described in the '370 patent, to check proper operation of a GAV require opening the valve.

### SUMMARY

The disclosure describes, in one aspect, an internal combustion engine. The engine includes a fuel system and cylinders. A fuel admission valve is associated with each cylinder and configured to connect the fuel system with each respective cylinder. A control unit is electrically connected to each of the fuel admission valves and, for each fuel admission valve, configured to provide an opening electrical current to open the fuel admission valve, a holding electrical current to hold the fuel admission valve in an open position and a detection electrical current to detect the position of the fuel admission valve. The control unit is further configured to determine whether the fuel admission valve is closed based on the time required to achieve the detection electrical current.

In another aspect, the disclosure describes a method of operating a fuel admission valve in an internal combustion engine having a control unit. The method provides an opening electrical current to the fuel admission valve. The opening electrical current is sufficient to open the fuel admission valve. The method further provides a holding electrical current to the fuel admission valve. The holding electrical current is sufficient to hold the fuel admission valve open. The method additionally provides a detection electrical current to the fuel admission valve. The detection electrical current is insufficient to open the fuel admission valve. A time required to achieve the detection electrical current is measured. The method detects whether the fuel admission valve is closed based on the time required to achieve the detection electrical current.

In yet another aspect, the disclosure describes a computer-readable medium having computer-executable instructions stored thereon which, when executed by a controller, will cause the controller to perform a method for operating a fuel admission valve in an internal combustion engine. The executed method provides an opening electrical current to the fuel admission valve. The opening electrical current is sufficient to open the fuel admission valve. The method further provides a holding electrical current to the fuel admission valve. The holding electrical current is sufficient to hold the fuel admission valve open. The executed method additionally provides a detection electrical current to the fuel admission valve. The detection electrical current is insufficient to open the fuel admission valve. A time required to achieve the detection electrical current is measured. The executed method detects whether the fuel admission valve is closed based on the time required to achieve the detection electrical current.

### BRIEF DESCRIPTION OF THE DRAWING(S)

FIG. 1 is a schematic drawing of an exemplary internal combustion engine in accordance with the disclosure;

FIG. 2 is a schematic cross-sectional view of a cylinder of a duel fuel internal combustion engine in accordance with the disclosure;

FIG. 3 is a diagram showing a current waveform for operation of a valve in accordance with the disclosure; and

FIG. 4 is a flow chart for a method in accordance with the disclosure.

### DETAILED DESCRIPTION

This disclosure relates to engine systems and, more particularly, to fuel admission valve systems and methods. Advantageously, in one embodiment, a control unit can determine whether a fuel admission valve is closed. The control unit causes a detection current to be sent to the valve. The detection current is insufficient to open the valve. The rise time required to meet the detection current is measured. If the rise time is longer than the expected rise time, then the valve is not closed. In some embodiments, the position of the valve can be determined based on the rise time required to achieve the detection current.

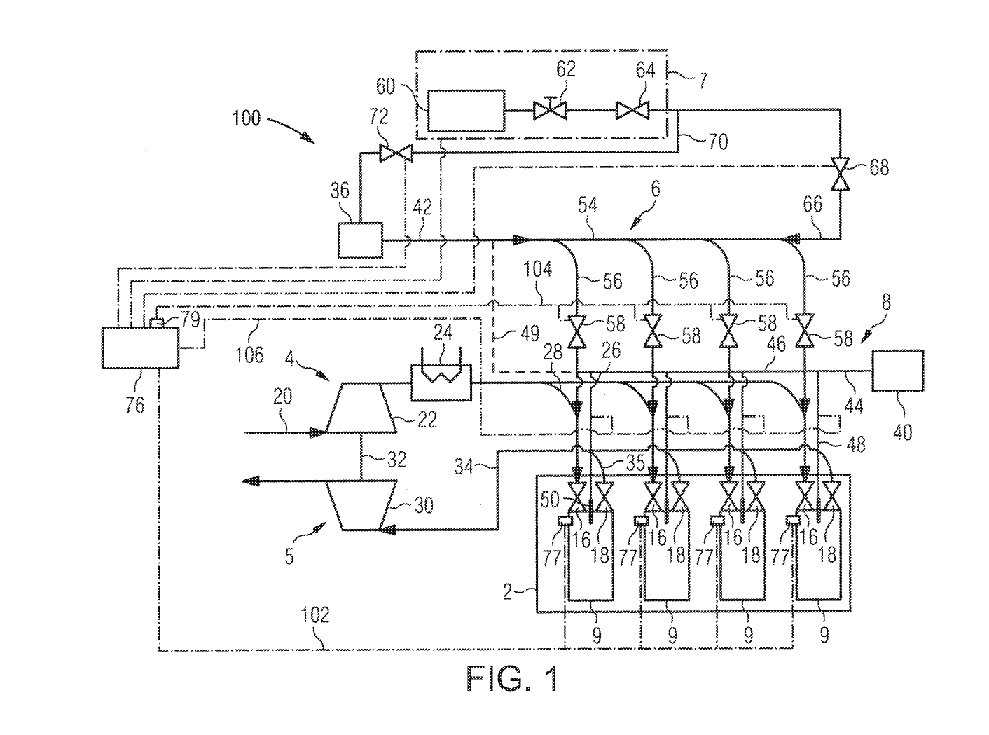

To provide context for one possible embodiment of the present disclosure, an internal combustion engine is shown in FIG. 1. The internal combustion engine may be used in any application requiring an engine, such as a machine. The arrangement disclosed herein has universal applicability in various types of machines as well. The term “machine” may refer to any machine that performs some type of operation associated with an industry such as mining, construction, farming, transportation, or any other industry known in the art. For example, the machine may be an earth-moving machine, such as a wheel loader, excavator, dump truck, backhoe, motor grader, material handler or the like. Moreover, an implement may be connected to the machine. Such implements may be utilized for a variety of tasks, including, for example, loading, compacting, lifting, brushing, and include, for example, buckets, compactors, forked lifting devices, brushes, grapples, cutters, shears, blades, breakers/hammers, augers, and others.

FIG. 1 illustrates an exemplary internal combustion engine 100. The internal combustion engine 100 may operate at least partly on gaseous fuel, such as a duel fuel engine or a gaseous engine. However, the systems described herein may apply to any system employing a valve.

The exemplary internal combustion engine 100 comprises an engine block 2, a charge air system 4, an exhaust gas system 5, a gaseous fuel system 6 including a purge gas system 7, and/or a liquid fuel system 8. Internal combustion engine 100 is powered with a gaseous fuel such as natural gas provided in a gaseous fuel mode (GFM), and may be powered with a liquid fuel such as, for example, diesel fuel in a liquid fuel mode (LFM) in dual fuel internal combustion engine configurations.

Engine block 2 includes a plurality of cylinders 9. Four cylinders 9 are depicted in FIG. 1. However, engine block 2 may be of any size, with any number of cylinders, such as 6, 8, 12, 16 or 20, and in any cylinder configuration, for example, “V”, in-line or radial configuration. Each cylinder 9 is equipped with at least one inlet valve 16 and at least one outlet valve 18. Inlet valves 16 are fluidly connected to charge air system 4 and configured to provide charge air, or a mixture of charge air and gaseous fuel, into cylinders 9. Outlet valves 18 are fluidly connected to exhaust gas system 5 and configured to direct exhaust gas out of respective cylinder 9.

Charge air is provided by the charge air system 4. The charge air system 4 may include an air intake 20, a compressor 22 to pressurize charge air, and a charge air cooler 24. A charge air manifold 26 is fluidly connected downstream of charge air cooler 24 to guide charge air through inlet channels 28, which are particular to each cylinder, into respective cylinders 9.

Exhaust gas system 5 may include an exhaust gas turbine 30 drivingly connected to compressor 22 via a shaft 32. Additionally, an exhaust gas manifold 34 is arranged downstream of cylinders 9 for guiding exhaust gas from individual exhaust gas outlet channels 35 to exhaust gas turbine 30. In some embodiments, charge air system 4 may comprise one or more charge air manifolds 26. Similarly, exhaust gas system 5 may comprise one or more exhaust gas manifolds 34.

Inlet valves 16 and outlet valves 18 may be installed within inlet channels 28 and outlet channels 35, respectively. Inlet channels 28 as well as outlet channels 35 may be provided within a common cylinder head covering more than one cylinder 9, or individual cylinder heads provided separately for each cylinder 9.

Gaseous fuel system 6 includes a gaseous fuel source 36 fluidly connected to gaseous fuel piping 42. Gaseous fuel source 36 constitutes a gaseous fuel feed for supplying gaseous fuel for combustion. For example, gaseous fuel source 36 may include a gaseous fuel tank that contains natural gas in a pressurized state, and a gas valve unit. The gas valve unit is configured to allow, to block, and/or to control flow from said gaseous fuel tank into gaseous fuel piping 42. The gas valve unit may comprise gaseous fuel control valves, gaseous fuel shut-off valves, and/or venting valves.

Gaseous fuel piping 42 is fluidly connected to a gaseous fuel manifold 54 which splits into a plurality of gaseous fuel channels 56. Each gaseous fuel channel 56 is fluidly connected to at least one of the plurality of inlet channels 28. A gaseous fuel admission valve (sometimes referred to as GAV) 58 introduces gaseous fuel into individual inlet channels 28, in each gaseous fuel channel 56. In some embodiments, internal combustion engine 100 may have more than one gaseous fuel manifold 54.

Each gaseous fuel admission valve 58 is configured to allow or to block flow of gaseous fuel into an individual inlet channel 28 to mix with compressed charge air from charge air system 4. Thus, cylinder specific mixing zones downstream of each gaseous fuel admission valve 58 are generated. For example, gaseous fuel admission valves 58 may be solenoid actuated gaseous fuel admission valves such as solenoid actuated plate valves, in which springs hold a lower surface of a movable disk against an upper surface of a stationary disk or plate. The two surfaces may be configured to provide a sealed relationship in a closed state of gaseous fuel admission valve 58. Each gaseous fuel admission valve 58 may be mounted to a cylinder head, which covers at least one cylinder 9.

Purge gas system 7 includes a purge gas tank 60, a purge gas control valve 62, and a purge gas shut-off valve 64 connected in series. Purge gas tank 60 includes a purge gas source to flush gaseous fuel piping 42 and gaseous fuel manifold 54 with a purge gas, such as nitrogen in a pressurized state. Purge gas system 7 may be fluidly connected to gaseous fuel system 6 at various locations. For example, a first connection 66 is disposed proximal to the gaseous fuel manifold 54. A second connection 70 is disposed proximal to gaseous fuel source 36. First shut-off valve 68 and second shut-off valve 72 can block or allow a purge gas flow through first connection 66 and second connection 70, respectively. Additional connections may be integrated, for example, in the gas valve unit of gaseous fuel source 36.

FIG. 1 generally illustrates a duel fuel internal combustion engine as well as a gaseous fuel engine. In a duel fuel internal combustion engine 200, liquid fuel system 8 comprises a liquid fuel tank 40 connected to liquid fuel piping 44. Liquid fuel tank 40 include a first liquid fuel tank for storing a first liquid fuel, for example, heavy fuel oil and a second liquid fuel tank for storing a second liquid fuel, for example, diesel fuel. Liquid fuel tank 40 constitutes a liquid fuel source for supplying liquid fuel for combustion in liquid fuel mode. Additionally, liquid fuel tank 40 may constitute a liquid fuel source for supplying ignition fuel in gaseous fuel mode. In gaseous fuel internal combustion engines, a liquid fuel system may be provided for igniting a gaseous fuel air mixture in cylinder 9. Alternatively, a gaseous fuel internal combustion engine may not include a liquid fuel system as ignition is caused in a different manner, for example by a spark plug.

Liquid fuel piping 44 is fluidly connected to a liquid fuel manifold 46 which splits into a plurality of liquid fuel inlet channels 48. To dose liquid fuel into a combustion chamber 10 of cylinder 9, in each liquid fuel inlet channel 48 a fuel injection system 50 is installed.

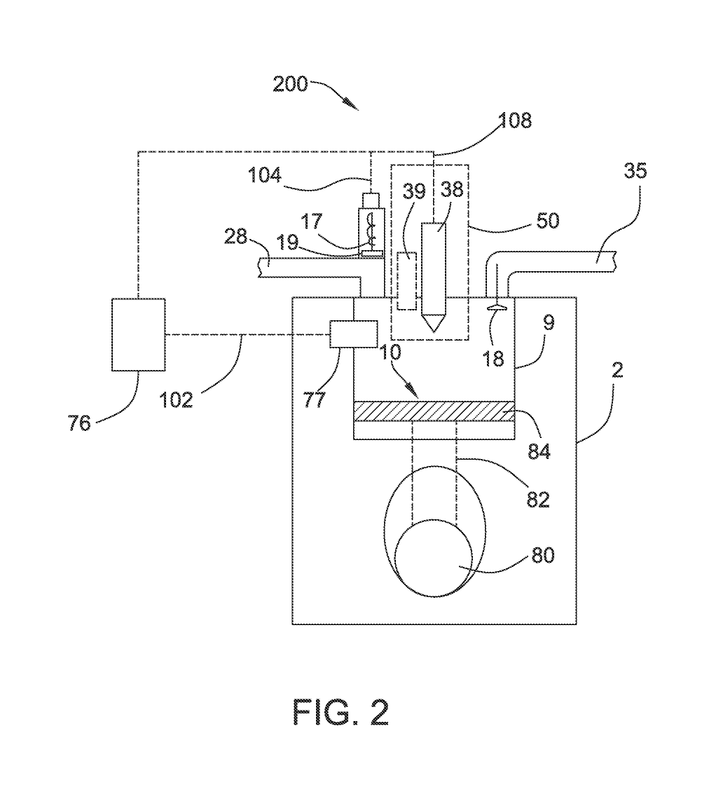

In a gaseous fuel internal combustion engine, such as a spark ignited gaseous fuel internal combustion system, fuel injection system 50 may be fluidly connected to gaseous fuel source 36 through connection 49 instead of liquid fuel tank 40. In this embodiment fuel injection system 50 may comprise a pre-combustion chamber for providing spark ignited ignition flames 91 (see FIG. 2) to ignite the mixture of gaseous fuel and air.

As shown in FIG. 1, internal combustion engine 100 may further include a plurality of pressure sensors 77 mounted at each cylinder 9. Each pressure sensor 77 is configured to generate a signal corresponding to a temporal development of an internal cylinder pressure during the operation of the engine, for example, during combustion.

To control operation of engine 100, a control unit 76 is provided. Control unit 76 forms part of a control system of engine 100. Control unit 76 is configured to receive data of pressure sensor 77 via a readout connection line 102. Control unit 76 may further be configured to control various components of engine 100 such as gaseous fuel admission valves 58 via a gaseous control connection line 104 and fuel injection system 50 via a fuel control connection line 106. Control unit 76 may further be configured to control valves of purge gas system 7.

A sensor 79, which is connected to control unit 76, is provided to measure an electrical operation parameter of each gaseous fuel admission valve 58 at least during actuation of the same. For example, sensor 79 may measure a temporal development of electric current value drawn by each gaseous fuel admission valve 58 during actuation as is described in greater detail below. In some embodiments, one sensor 79 may be configured to monitor all gaseous fuel admission valves 58, in other embodiments, more than one sensor 79 may be provided, for example, one sensor per gaseous fuel admission valve 58.

FIG. 2 illustrates a cylinder 9 of a duel fuel internal combustion engine 200 which is an exemplary embodiment of internal combustion engine 100 of FIG. 1. Elements already described in connection with FIG. 1 have the same reference numerals, such as engine block 2, control unit 76, pressure sensor 77, and cylinder 9.

Cylinder 9 provides at least one combustion chamber 10 for combusting a mixture of fuel and air, a piston 84, and a crankshaft 80 which is connected to piston 84 via a piston rod 82. Piston 84 is configured to reciprocate within cylinder 9. Cylinder 9 is connected to charge air manifold 26 via inlet channel 28 and to exhaust gas manifold 34 via outlet channel 35 (see FIG. 1). Inlet valve 16 is disposed in inlet channel 28, and outlet valve 18 is disposed in outlet channel 35. Gaseous fuel admission valve 58 can supply gaseous fuel to combustion chamber 10 of cylinder 9.

FIG. 2 further illustrates fuel injection system 50. When duel fuel internal combustion engine 200 is operated in liquid fuel mode, fuel injection system 50 is used to inject liquid fuel into combustion chamber 10, the liquid fuel being the sole source of energy. When duel fuel internal combustion engine 200 is operated in gaseous fuel mode, fuel injection system 50 may be used to inject an ignition amount of liquid fuel into combustion chamber 10 to ignite a mixture of gaseous fuel and air. In gaseous fuel mode, fuel injection system 50 may therefore function as an ignition system.

In FIG. 2, an exemplary embodiment of such an ignition system is based on a main liquid fuel injector 38 for injecting a large amount of liquid fuel in liquid fuel mode and an ignition amount of liquid fuel into combustion chamber 10 to ignite the mixture of gaseous fuel and air in gaseous fuel mode. In other embodiments, such as for heavy duty duel fuel internal combustion engines, a gaseous fuel ignition system may comprise a separate ignition liquid fuel injector 39 to inject the ignition amount of liquid fuel into combustion chamber 10 in gaseous fuel mode.

Duel fuel internal combustion engine 200 additionally comprises a control system including control unit 76. Control unit 76 is connected to main liquid fuel injector 38 via injector control connection line 108 and, in case of heavy duty duel fuel internal combustion engines, also to ignition liquid fuel injector 39.

In some embodiments, sensor 79 for measuring an electrical operation parameter of gaseous fuel admission valve 58 is directly coupled to gaseous fuel admission valve 58, and/or integrated in gaseous fuel admission valve 58. Alternatively, sensor 79 may, for example, form part of control unit 76 as schematically shown in FIG. 1. Gaseous fuel admission valve 58 includes metering plate 19 and solenoid coil 17.

In general, control unit 76 may be a single microprocessor or multiple microprocessors that control the operation of various components of internal combustion engine 100. Control unit 76 may be a general engine control unit (ECU) capable of controlling numerous functions associated with internal combustion engine 100 and/or its associated components. Control unit 76 may include all components required to run an application such as, for example, a memory, a secondary storage device, such as a non-transitory computer-readable medium, and a processor such as a central processing unit or any other means known in the art for controlling internal combustion engine 100 and its components. Various other known circuits may be associated with control unit 76, including power supply circuitry, signal conditioning circuitry, communication circuitry and other appropriate circuitry. Control unit 76 may analyze and compare received and stored data and, based on instructions and data stored in memory or input by a user, determine whether action is required. For example, control unit 76 may compare received pressure data from pressure sensor 77 with target values stored in memory, and, based on the results of the comparison, transmit signals to one or more components of the engine 100 to alter its operation.

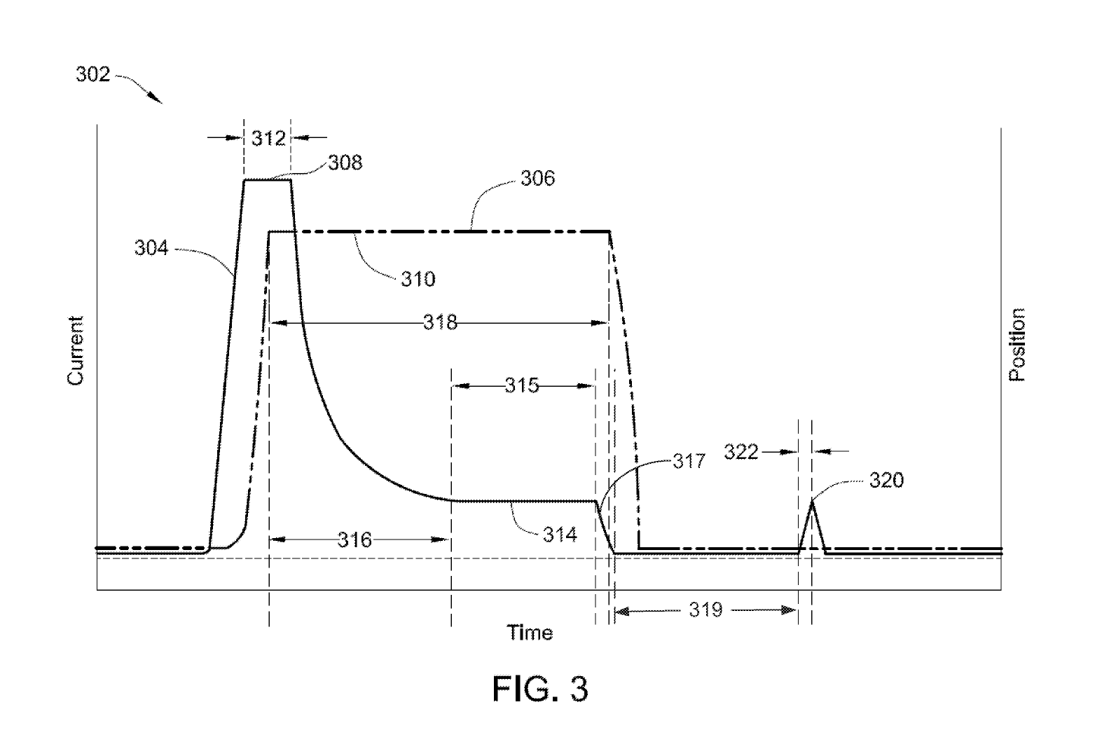

FIG. 3 is a diagram showing a chart 302 including a current waveform 304 and position waveform 306 for operation of a fuel admission valve, such as the gaseous fluid admission valve 58 described above. In the chart 302, the current waveform 304 is denoted by a solid line and the position waveform 306 is denoted by a dashed line. The current waveform 304 has various time intervals or segments, as dictated by the control unit 76, to control the gaseous fuel admission valve 58. As shown in FIG. 3, the control unit 76 provides an opening electrical current 308, or a pull-in current, to open the gaseous fuel admission valve 58. The opening electrical current 308 is held for a first time interval 312. The control unit 76 then provides a holding electrical current 314 to hold the fuel admission valve in an open position. As can be seen, the current transitions from the opening electrical current 308 to the holding electrical current 314 during transition time interval 316. The holding electrical current 314 is maintained during a holding time interval 315. The valve is therefore open during time period 318, which is the sum of the transition time interval 316 and the holding time interval 315.

The control unit 76 thereafter applies a turn-off electrical current 317 to close the gaseous fuel admission valve 58. The gaseous fuel admission valve 58 is closed during an interim turn-off interval 319.

The control unit 76 provides a detection electrical current 320 to detect the position of the fuel admission valve. The control unit 76 can determine whether the gaseous fuel admission valve 58 is closed based on a rise time 322, or the time required to achieve the detection electrical current 320. The position of the metering plate 19 causes the inductance of the solenoid coil 17 in the gaseous fuel admission valve 58 to vary. In some embodiments, the inductance of the solenoid coil 17 increases in a known relationship to the position of the metering plate 19. Therefore, in some embodiments, the rise time 322 directly relates to the position of the metering plate 19. In this way, the control unit 76 may be configured to determine whether a fuel admission valve, such as gaseous fuel admission valve 58, is closed using a look up table. Additionally, the control unit 76 may be able to determine the position of the fuel admission valve based on the time required to achieve the detection electrical current 320, or rise time 322. In some embodiments, the detection electrical current 320 is smaller than the opening electrical current 308. Therefore, the detection electrical current 320 is insufficient to open the fuel admission valve, gaseous fuel admission valve 58.

### INDUSTRIAL APPLICABILITY

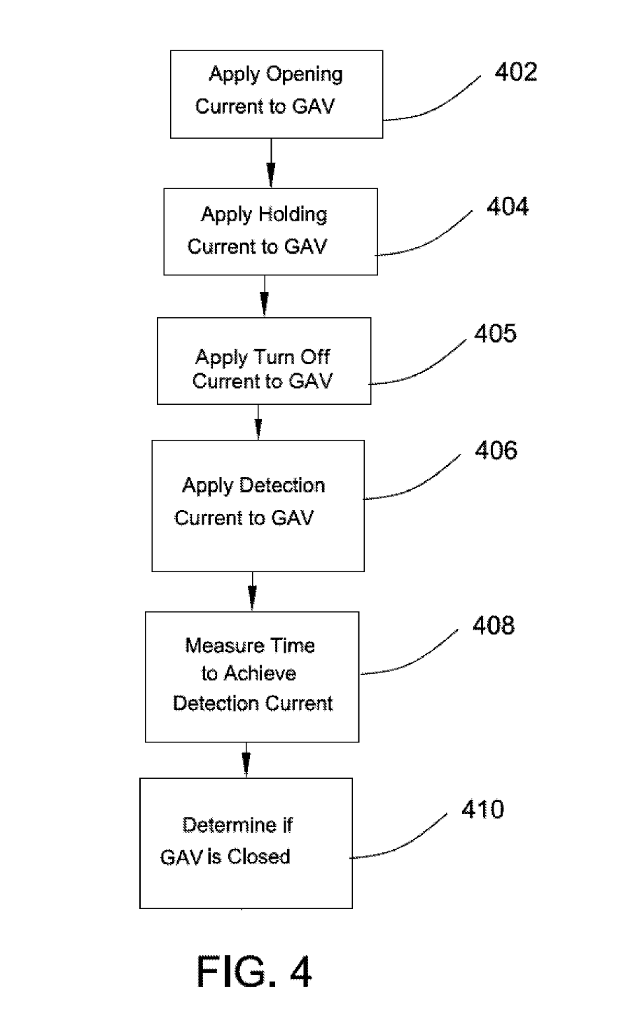

The present disclosure is applicable to internal combustion engines such as internal combustion engine 100 and more particularly, to fuel admission valve systems associated with an internal combustion engine. A flowchart for a method of controlling a fuel admission valve such as gaseous fuel admission valve 58 is shown in FIG. 4. The process includes providing an opening electrical current to the gaseous fuel admission valve 58, at a block 402. The opening electrical current is sufficient to open the gaseous fuel admission valve 58. At block 404, a holding electrical current is provided to the gaseous fuel admission valve 58. The holding electrical current at the block 404 is sufficient to hold the gaseous fuel admission valve 58 open. At block 405, a turn-off current is applied to allow the gaseous fuel admission valve 58 to close. The method additionally provides a detection electrical current to the gaseous fuel admission valve 58 at block 406. The detection electrical current is insufficient to open the gaseous fuel admission valve 58. At block 408, a time required to achieve the detection electrical current is measured. At block 410, the method includes detecting whether the gaseous fuel admission valve 58 is closed based on the time required to achieve the detection electrical current.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I claim:

1. An internal combustion engine, comprising:
a fuel system;
a plurality of cylinders;
a plurality of gaseous fuel admission valves, each gaseous fuel admission valve associated with each cylinder of the plurality of cylinders and configured to connect the fuel system with each respective cylinder; and
a control unit electrically connected to each of the plurality of gaseous fuel admission valves and, for each fuel admission valve, configured to provide an opening electrical current to open the gaseous fuel admission valve, a holding electrical current to hold the gaseous fuel admission valve in an open position and a detection electrical current to detect a position of the gaseous fuel admission valve and wherein the control unit is further configured to determine whether the gaseous fuel admission valve is closed based on a time required to achieve the detection electrical current.

2. The internal combustion engine of claim 1 wherein the control unit is further configured to determine the position of the gaseous fuel admission valve based on the time required to achieve the detection electrical current.

3. The internal combustion engine of claim 2 wherein the control unit is configured to determine whether the position of the gaseous fuel admission valve is closed using a look up table.

4. The internal combustion engine of claim 3 wherein the internal combustion engine is configured as a gaseous engine.

5. The internal combustion engine of claim 1 wherein the gaseous fuel admission valve further comprises a solenoid coil and a metering plate.

6. The internal combustion engine of claim 1 wherein the internal combustion engine is configured as a gaseous engine.

7. The internal combustion engine of claim 1 wherein the internal combustion engine is configured as a duel fuel engine.

8. The internal combustion engine of claim 1 wherein the control unit is configured to determine whether the gaseous fuel admission valve is closed using a look up table.

9. A method of operating a gaseous fuel admission valve in an internal combustion engine having a control unit, the method comprising:
providing an opening electrical current to the gaseous fuel admission valve, the opening electrical current being sufficient to open the gaseous fuel admission valve;
providing a holding electrical current to the gaseous fuel admission valve, the holding electrical current being sufficient to hold the gaseous fuel admission valve open;
providing a detection electrical current to the gaseous fuel admission valve, the detection electrical current being insufficient to open the gaseous fuel admission valve;
measuring a time required to achieve the detection electrical current; and
detecting whether the gaseous fuel admission valve is closed based on the time required to achieve the detection electrical current.

10. The method of claim 9 further comprising determining a position of the gaseous fuel admission valve based on the time required to achieve the detection electrical current.

11. The method of claim 9 wherein the gaseous fuel admission valve comprises a solenoid coil and a metering plate.

12. The method of claim 11 further comprising determining a position of the metering plate in the gaseous fuel admission valve.

13. The method of claim 9 wherein the internal combustion engine is configured as a gaseous engine.

14. The method of claim 9 wherein the internal combustion engine is configured as a duel fuel engine.

15. A non-transitory computer-readable medium having computer-executable instructions stored thereon which, when executed by a controller, will cause the controller to perform a method for of operating a gaseous fuel admission valve in an internal combustion engine, comprising:
providing an opening electrical current to the gaseous fuel admission valve, the opening electrical current being sufficient to open the gaseous fuel admission valve;
providing a holding electrical current to the gaseous fuel admission valve, the holding electrical current being sufficient to hold the gaseous fuel admission valve open;
providing a detection electrical current to the gaseous fuel admission valve, the detection electrical current being insufficient to open the gaseous fuel admission valve;
measuring a time required to achieve the detection electrical current; and
detecting whether the gaseous fuel admission valve is closed based on the time required to achieve the detection electrical current.

16. The non-transitory computer-readable medium of claim 15, further comprising instructions for determining a position of the gaseous fuel admission valve based on the time required to achieve the detection electrical current.

17. The non-transitory computer-readable medium of claim 15, wherein the gaseous fuel admission valve comprises a solenoid coil and a metering plate.

18. The non-transitory computer-readable medium of claim 17, further comprising instructions for determining a position of the metering plate in the gaseous fuel admission valve.

19. The non-transitory computer-readable medium of claim 15, wherein the internal combustion engine is configured as a gaseous engine.

20. The non-transitory computer-readable medium of claim 15, wherein the internal combustion engine is configured as a duel fuel engine.
